(19) United States
(12) Patent Application Publication
(10) Pub. No.: US 2024/0002222 A1
(43) Pub. Date: Jan. 4, 2024

(54) METHOD FOR PREPARING HYDROGEN FROM SECONDARY ALUMINUM ASH

(71) Applicant: Guangdong Zhidao Advanced Civil Engineering Materials Technology Research Co., Ltd., Foshan (CN)

(72) Inventors: Dakang Zhang, Foshan (CN); Wenhui Kuang, Foshan (CN); Junli Zhao, Foshan (CN); Yulu Zhang, Foshan (CN); Siyi Wang, Foshan (CN)

(21) Appl. No.: 18/127,251

(22) Filed: Mar. 28, 2023

(30) Foreign Application Priority Data
Jun. 29, 2022 (CN) 202210750665.9

(51) Int. Cl. C01B 3/08; C01B 3/52; C01B 3/56; B01D 53/14; B01D 53/047

(52) U.S. Cl. CPC C01B 3/08; C01B 3/52; C01B 3/56; B01D 53/14; B01D 53/047; C01B 2203/0415; C01B 2203/042; C01B 2203/0465; C01P 2006/80; B01D 2257/406; B01D 2257/108

(57) ABSTRACT

The present disclosure discloses a method for preparing hydrogen from secondary aluminum ash, including the following steps: S1. preparing secondary aluminum ash, and subjecting a reaction device to an oxygen replacement treatment; S2. feeding the secondary aluminum ash into the reaction device, adding water, conducting a first hydrolysis reaction to obtain a first gas, and introducing the first gas into a gas collection cabinet; S3. adding calcium hydroxide and sodium hydroxide subsequently to the reaction device, conducting a second hydrolysis reaction to obtain a second gas, and introducing the second gas into the gas collection cabinet; and S4. subjecting a gas mixture in the gas collection cabinet to separation and purification to obtain hydrogen. The method is conducive to improving a hydrogen yield and reducing the toxicity of process products.

### CROSS-REFERENCE TO RELATED APPLICATION

The present application claims priority from Chinese Patent Application No. 202210750665.9 filed on Jun. 29, 2022, the contents of which are incorporated herein by reference in their entirety.

### TECHNICAL FIELD

The present disclosure relates to the technical field of comprehensive utilization of secondary aluminum ash, and in particular to a method for preparing hydrogen from secondary aluminum ash.

### BACKGROUND

Aluminum ash includes primary aluminum ash and secondary aluminum ash, which are hazardous solid waste generated in the aluminum industry. Aluminum ash mainly includes the following components in mass fraction: metallic aluminum:10% to 30%; aluminum oxide:20% to 40%; oxides of silicon, magnesium, and iron:7% to 15%; and chlorides of potassium, sodium, calcium, and magnesium and other trace fluorides:15% to 30%. According to the number of uses of aluminum ash during a recycling process and the content of metallic aluminum in aluminum ash, aluminum ash can be divided into primary aluminum ash and secondary aluminum ash. Primary aluminum ash is a dross that is produced during an electrolysis process of aluminum oxide to produce primary aluminum and does not melt in molten aluminum, which is usually white and thus is also known as white aluminum dross. Primary aluminum ash has a metallic aluminum content of 30% to 85%, and also includes a fluoride salt, aluminum oxide, aluminum nitride, or the like. Secondary aluminum ash is an ash residue produced during a process of remelting primary aluminum ash or scrap aluminum to recover metallic aluminum in the secondary aluminum industry, which is black and thus is also known as black ash. Secondary aluminum ash has a metallic aluminum content of 5% to 20%, and also includes aluminum oxide, aluminum nitride, a fluoride salt, a chloride salt, silicon dioxide, or the like.

In the prior art, a wet treatment method is often used to conduct a harmless treatment on secondary aluminum ash, where water is the most common solvent in the wet treatment. In the process of wet treatment with water, elemental aluminum, aluminum nitride, and aluminum carbide in secondary aluminum ash undergo hydrolysis to produce hydrogen, ammonia, and methane, respectively, and a complicated separation treatment is required to separate pure hydrogen from a mixed gas of these gases. In addition, in order to improve a reaction degree of hydrolysis, a hydrolysis environment with high pH is often required to make active substances fully react. However, the fluoride will be leached out in a large quantity at a high pH, which greatly increases the toxicity of an aqueous reaction solution.

### SUMMARY

The technical problem to be solved by the present disclosure is to provide a method for preparing hydrogen from secondary aluminum ash, which can easily achieve the separation of hydrogen and is conducive to improving a hydrogen yield and reducing the toxicity of process products.

To solve the above technical problem, the present disclosure provides a method for preparing hydrogen from secondary aluminum ash, including the following steps:
S1. preparing secondary aluminum ash, and subjecting a reaction device to an oxygen replacement treatment;
S2. feeding the secondary aluminum ash into the reaction device, adding water, conducting a first hydrolysis reaction to obtain a first gas, and introducing the first gas into a gas collection cabinet;
S3. adding calcium hydroxide and sodium hydroxide subsequently to the reaction device, conducting a second hydrolysis reaction to obtain a second gas, and introducing the second gas into the gas collection cabinet; and
S4. subjecting a gas mixture in the gas collection cabinet to separation and purification to obtain hydrogen,
where a reaction time of the second hydrolysis reaction is longer than a reaction time of the first hydrolysis reaction.

In an embodiment, in S1, the secondary aluminum ash has a particle size of less than 100 μm; and
during the oxygen replacement treatment, air in the reaction device is replaced with an inert gas to make a volume proportion of oxygen in the reaction device less than 0.2%.

In an embodiment, in S2, during the first hydrolysis reaction, a solid-to-liquid ratio of the secondary aluminum ash to the water is 1:(3-8); the first hydrolysis reaction is conducted at to 60° C.; and
a preset time for the first hydrolysis reaction is 4 h to 20 h.

In an embodiment, in S2, during the first hydrolysis reaction, a solid-to-liquid ratio of the secondary aluminum ash to the water is 1:(4-7); the first hydrolysis reaction is conducted at 35° C. to 55° C.; and
a preset time for the first hydrolysis reaction is 5 h to 15 h.

In an embodiment, in S3, an amount of the calcium hydroxide is 5% to 50% of an amount of the secondary aluminum ash; and
an amount of the sodium hydroxide is 1% to 10% of the amount of the secondary aluminum ash.

Preferably, in S3, an amount of the calcium hydroxide is 8% to 20% of an amount of the secondary aluminum ash; and
an amount of the sodium hydroxide is 3% to 5% of the amount of the secondary aluminum ash.

In an embodiment, in S3, during the second hydrolysis reaction, a solid-to-liquid ratio of the secondary aluminum ash to the water is 1:(3-8); the second hydrolysis reaction is conducted at 50° C. to 95° C.; an initial pH for the second hydrolysis reaction is 11 to 14; and
a preset time for the second hydrolysis reaction is 20 h to 60 h.

In an embodiment, in S3, the calcium hydroxide, the sodium hydroxide, and a catalyst are added to the reaction device to conduct the second hydrolysis reaction; and an amount of the catalyst is 0.01% to 10% of an amount of the secondary aluminum ash, and
the catalyst is one or more selected from the group consisting of hydrogen peroxide, sodium carbonate, potassium carbonate, potassium hydroxide, and sodium stannate.

In an embodiment, in S3, during the second hydrolysis reaction, the sodium hydroxide and the catalyst are first added to react for 10 h to 30 h, and then the calcium hydroxide is added.

In an embodiment, the gas mixture in the gas collection cabinet is subjected to separation and purification as follows:
cooling the gas mixture in the gas collection cabinet to 35° C. or lower, absorbing ammonia with an ammonia spray and absorption tower, and separating hydrogen from other gases through pressure swing adsorption (PSA) to obtain hydrogen with a purity of 99.99% or higher.

The present disclosure has the following beneficial effects:

The present disclosure provides a method for preparing hydrogen from secondary aluminum ash, including a first hydrolysis reaction and a second hydrolysis reaction, where a reaction time of the second hydrolysis reaction is longer than a reaction time of the first hydrolysis reaction. During the first hydrolysis reaction, water is only added to react with active substances in the secondary aluminum ash, which can consume aluminum nitride and aluminum carbide in the secondary aluminum ash to some extent. During the second hydrolysis reaction, calcium hydroxide and sodium hydroxide are added to make elemental aluminum completely hydrolyzed, thereby improving a hydrogen yield; and calcium hydroxide can reduce free fluorides in a solution, thereby reducing the toxicity of process products.

Moreover, compared with the existing hydrogen production methods, such as hydrogen production from a fossil fuel, hydrogen production through electrolysis of water, hydrogen production from a biomass, hydrogen production through solar photolysis of water, and hydrogen production with nuclear energy, the method for preparing hydrogen provided by the present disclosure has the following advantages: 1. The method of the present disclosure greatly reduces the cost of hydrogen production and leads to hydrogen with a low price. A hydrogen production cost of the method of the present disclosure is only one-third of a cost of the hydrogen production from a fossil fuel and one-quarter of a cost of the hydrogen production through electrolysis of water. In addition, the energy consumption for the hydrogen production of the present disclosure is extremely low, and the production of a cubic meter of hydrogen consumes only 0.5 kWh of electricity and a small amount of thermal energy.

### DETAILED DESCRIPTION

To make the objectives, technical solutions, and advantages of the present disclosure clearer, the present disclosure will be further described in detail below in combination with specific embodiments.

To solve the above technical problem, the present disclosure provides a method for preparing hydrogen from secondary aluminum ash, including the following steps:

S1. Secondary aluminum ash is prepared, and a reaction device is subjected to an oxygen replacement treatment.

A particle size of the secondary aluminum ash will affect a final hydrogen content. In an embodiment, the secondary aluminum ash has a particle size of less than 100 μm, which can improve a yield of hydrogen.

In addition, in order to ensure the safety of the subsequent preparation process, it is necessary to subject the reaction device to an oxygen replacement treatment in advance, thereby avoiding explosion caused by the mixing of a large amount of hydrogen with oxygen subsequently. In an embodiment, during the oxygen replacement treatment, air in the reaction device is replaced with an inert gas to make a volume proportion of oxygen in the reaction device less than 0.2%.

S2. The secondary aluminum ash is fed into the reaction device, water is added, a first hydrolysis reaction is conducted to obtain a first gas, and the first gas is introduced into a gas collection cabinet.

In the prior art, only one-time hydrolysis is often adopted to conduct a wet treatment on secondary aluminum ash. During the one-time hydrolysis, aluminum nitride, elemental aluminum, and aluminum carbide in the secondary aluminum ash undergo hydrolysis successively to produce ammonia, hydrogen, and methane, respectively, and thus a large amount of a mixed gas is produced at one time, which requires a complicated separation and purification system subsequently to obtain pure hydrogen, resulting in poor practicability of hydrogen production from secondary aluminum ash. In addition, in the secondary aluminum ash, elemental aluminum is often agglomerated with aluminum oxide and aluminum nitride in the form of fine particles, where aluminum oxide and aluminum nitride wrap around the elemental aluminum, which is not conducive to the hydrolysis of elemental aluminum to produce hydrogen.

In order to solve the above problem, the present disclosure subjects secondary aluminum ash to two-phase hydrolysis including a first hydrolysis reaction and a second hydrolysis reaction, where a reaction time of the second hydrolysis reaction is longer than a reaction time of the first hydrolysis reaction.

During the first hydrolysis reaction, only water is added to react with active substances in the secondary aluminum ash, and aluminum nitride preferentially reacts with water due to its large specific surface area (SSA), such that aluminum nitride in the secondary aluminum ash is consumed to some extent, which is conducive to the thorough reaction of elemental aluminum during the second hydrolysis reaction. Moreover, ammonia obtained by the hydrolysis of aluminum nitride can also be dissolved in water, thereby reducing the pressure on the subsequent gas separation and purification. Furthermore, the removal of aluminum nitride during the first hydrolysis reaction facilitates the exposure of the encapsulated elemental aluminum to a water environment, resulting in a hydrolysis reaction.

Further, the solid-to-liquid ratio, reaction temperature, and reaction time during the first hydrolysis reaction will determine whether the purpose of the first hydrolysis reaction can be fully achieved. The solid-to-liquid ratio and reaction temperature will affect the hydrolysis rate. In an embodiment, in S2, during the first hydrolysis reaction, a solid-to-liquid ratio of the secondary aluminum ash to the water is 1:(3-8); and the first hydrolysis reaction is conducted at 25° C. to 60° C. A too-large solid-to-liquid ratio or a too-high reaction temperature will increase the hydrolysis rate, such that both aluminum nitride and elemental aluminum are completely hydrolyzed during the first hydrolysis reaction, making the staged hydrolysis of the active substances in the secondary aluminum ash failed. A too-small solid-to-liquid ratio or a too-low reaction temperature makes aluminum nitride unable to be completely hydrolyzed during the first hydrolysis reaction, thus failing to reduce the pressure on the subsequent gas separation. Preferably, during the first hydrolysis reaction, a solid-to-liquid ratio of the secondary aluminum ash to the water is 1:(4-7); and the first hydrolysis reaction is conducted at 35° C. to 55° C.

In addition, the first hydrolysis reaction time is an important factor for controlling the hydrolysis progress, to make sure the hydrolysis of aluminum nitride and aluminum carbide are the main reactions taking place during the first hydrolysis reaction stage, thereby the gas generated by the first hydrolysis can be separated more easily. In an embodiment, a preset time for the first hydrolysis reaction is 4 h to 20 h. Preferably, a preset time for the first hydrolysis reaction is 5 h to 15 h.

S3. Calcium hydroxide and sodium hydroxide are added subsequently to the reaction device, a second hydrolysis reaction is conducted to obtain a second gas, and the second gas is introduced into the gas collection cabinet.

During the first hydrolysis reaction, aluminum nitride and aluminum carbide in the secondary aluminum ash are consumed as much as possible due to relatively adequate hydrolysis, and the removal of aluminum nitride makes the encapsulated elemental aluminum gradually exposed to a water environment. Therefore, the second hydrolysis reaction of the present disclosure is mainly intended to achieve the adequate hydrolysis of elemental aluminum. By adding calcium hydroxide and sodium hydroxide during the second hydrolysis reaction, the aluminum oxide wrapped around the elemental aluminum can be further removed to increase a contact area between the elemental aluminum and water, the elemental aluminum can be completely hydrolyzed to improve a hydrogen yield, and calcium hydroxide can reduce free fluorides in a solution to reduce the toxicity of process products.

The amounts of the calcium hydroxide and sodium hydroxide will affect the initial pH for the second hydrolysis reaction, thereby affecting whether the hydrolysis reaction can be conducted adequately. In an embodiment, in S3, an amount of the calcium hydroxide is 5% to 50% of an amount of the secondary aluminum ash; and an amount of the sodium hydroxide is 1% to 10% of the amount of the secondary aluminum ash. Preferably, in S3, an amount of the calcium hydroxide is 8% to 20% of an amount of the secondary aluminum ash; and an amount of the sodium hydroxide is 3% to 5% of the amount of the secondary aluminum ash. Correspondingly, the initial pH for the second hydrolysis reaction is 11 to 14, and compared with the first hydrolysis reaction, the second hydrolysis reaction is conducted under alkaline conditions, which is conducive to hydrogen production.

Further, the solid-to-liquid ratio, reaction temperature, and reaction time for the second hydrolysis reaction will also affect the progress of the reaction. In an embodiment, in S3, during the second hydrolysis reaction, a solid-to-liquid ratio of the secondary aluminum ash to the water is 1:(3-8); the second hydrolysis reaction is conducted at 50° C. to 95° C.; and a preset time for the second hydrolysis reaction is 20 h to 60 h.

In addition, in order to maximize the hydrolysis of the elemental aluminum in the secondary aluminum ash to produce hydrogen during the second hydrolysis reaction, a specified amount of a catalyst can be further added during the second hydrolysis reaction, and the catalyst is conducive to the hydrolysis of the elemental aluminum to produce hydrogen. In an embodiment, an amount of the catalyst is 0.01% to 10% of an amount of the secondary aluminum ash, and the catalyst is one or more selected from the group consisting of hydrogen peroxide, sodium carbonate, potassium carbonate, potassium hydroxide, and sodium stannate.

It should be noted that, in addition to aluminum nitride, aluminum carbide, and elemental aluminum, there is a specified amount of a fluoride in the secondary aluminum ash, and a concentration of the fluoride in a reaction solution under neutral conditions is relatively low, but with the increase of pH in a reaction environment, the dissolution of the fluoride is accelerated, which makes a concentration of the fluoride in the reaction solution gradually increased, resulting in increased toxicity of the reaction solution. In the present disclosure, calcium hydroxide is introduced to assist sodium hydroxide to further improve a pH of a system to some extent and help the hydrolysis of elemental aluminum to produce hydrogen; and the introduced calcium hydroxide can also react with the fluoride in the reaction solution to produce a calcium fluoride precipitate, thereby playing a role in fixing fluorine and reducing the toxicity of the reaction solution.

In an embodiment, in S3, during the second hydrolysis reaction, the sodium hydroxide and the catalyst are first added to react for 10 h to 30 h, and then the calcium hydroxide is added. The sodium hydroxide and catalyst are first added to increase a pH of a reaction system and accelerate the hydrolysis of elemental aluminum to produce hydrogen; and after the preset reaction time, calcium hydroxide is then added to supplement OH⁻ to the reaction system, and calcium hydroxide can react with harmful fluoride ions in the reaction solution to produce a precipitate, which can be easily removed subsequently.

S4. A gas mixture in the gas collection cabinet is subjected to separation and purification to obtain hydrogen.

In an embodiment, the gas mixture in the gas collection cabinet is subjected to separation and purification as follows: cooling the gas mixture in the gas collection cabinet to 35° C. or lower, absorbing ammonia with an ammonia spray and absorption tower, and separating hydrogen from other gases through PSA to obtain hydrogen with a purity of 99.99% or higher. An impurity content of the obtained hydrogen is lower than that specified in GB/T37244, and a quality of hydrogen meets the provisions of GB/T37244.

The present disclosure is described below with reference to specific examples.

### Example 1

A method for preparing hydrogen from secondary aluminum ash was provided, including the following steps:

S1. Secondary aluminum ash was prepared, and a reaction device was subjected to an oxygen replacement treatment.

The secondary aluminum ash had a particle size of less than 100 μm; and air in the reaction device was replaced with nitrogen to make a volume proportion of oxygen in the reaction device less than 0.2%.

S2. The secondary aluminum ash was fed into the reaction device, water was added, a first hydrolysis reaction was conducted to obtain a first gas, and the first gas was introduced into a gas collection cabinet.

During the first hydrolysis reaction, a solid-to-liquid ratio of the secondary aluminum ash to the water was 1:5; the first hydrolysis reaction was conducted at 50° C.; and a preset time for the first hydrolysis reaction was 10 h.

S3. Calcium hydroxide, sodium hydroxide, and a catalyst were added subsequently to the reaction device, a second hydrolysis reaction was conducted to obtain a second gas, and the second gas was introduced into the gas collection cabinet.

During the second hydrolysis reaction, a solid-to-liquid ratio of the secondary aluminum ash to the water was 1:5; and the second hydrolysis reaction was conducted at 85° C.

Sodium hydroxide and sodium stannate were first added to the reaction device to react for 20 h, and then calcium hydroxide was added to further react for 20 h to 30 h, where an amount of the sodium hydroxide was 3% of an amount of the secondary aluminum ash, an amount of the sodium stannate was 1.5% of the amount of the secondary aluminum ash, and an amount of the calcium hydroxide was 15% of the amount of the secondary aluminum ash.

S4. A gas mixture in the gas collection cabinet was subjected to separation and purification to obtain hydrogen.

The gas mixture in the gas collection cabinet was cooled to 35° C. or lower, ammonia was absorbed with an ammonia spray and absorption tower, and hydrogen was separated from other gases through PSA to obtain hydrogen with a purity of 99.99% or higher.

### Example 2

A method for preparing hydrogen from secondary aluminum ash was provided, including the following steps:

S1. Secondary aluminum ash was prepared, and a reaction device was subjected to an oxygen replacement treatment.

The secondary aluminum ash had a particle size of less than 100 μm; and air in the reaction device was replaced with nitrogen to make a volume proportion of oxygen in the reaction device less than 0.2%.

S2. The secondary aluminum ash was fed into the reaction device, water was added, a first hydrolysis reaction was conducted to obtain a first gas, and the first gas was introduced into a gas collection cabinet.

During the first hydrolysis reaction, a solid-to-liquid ratio of the secondary aluminum ash to the water was 1:5; the first hydrolysis reaction was conducted at 50° C.; and a preset time for the first hydrolysis reaction was 15 h.

S3. Calcium hydroxide, sodium hydroxide, and a catalyst were added subsequently to the reaction device, a second hydrolysis reaction was conducted to obtain a second gas, and the second gas was introduced into the gas collection cabinet.

During the second hydrolysis reaction, a solid-to-liquid ratio of the secondary aluminum ash to the water was 1:5; and the second hydrolysis reaction was conducted at 85° C.

Sodium hydroxide, sodium stannate, and potassium carbonate were first added to the reaction device to react for 20 h, and then calcium hydroxide was added to further react for 20 h to 30 h, where an amount of the sodium hydroxide was 1% of an amount of the secondary aluminum ash, an amount of the sodium stannate was 1.5% of the amount of the secondary aluminum ash, an amount of the potassium carbonate was 20% of the amount of the secondary aluminum ash, and an amount of the calcium hydroxide was 5% of the amount of the secondary aluminum ash.

S4. A gas mixture in the gas collection cabinet was subjected to separation and purification to obtain hydrogen.

The gas mixture in the gas collection cabinet was cooled to 35° C. or lower, ammonia was absorbed with an ammonia spray and absorption tower, and hydrogen was separated from other gases through PSA to obtain hydrogen with a purity of 99.99% or higher.

### Example 3

A method for preparing hydrogen from secondary aluminum ash was provided, including the following steps:

S1. Secondary aluminum ash was prepared, and a reaction device was subjected to an oxygen replacement treatment.

The secondary aluminum ash had a particle size of less than 100 μm; and air in the reaction device was replaced with nitrogen to make a volume proportion of oxygen in the reaction device less than 0.2%.

S2. The secondary aluminum ash was fed into the reaction device, water was added, a first hydrolysis reaction was conducted to obtain a first gas, and the first gas was introduced into a gas collection cabinet.

During the first hydrolysis reaction, a solid-to-liquid ratio of the secondary aluminum ash to the water was 1:5; the first hydrolysis reaction was conducted at 50° C.; and a preset time for the first hydrolysis reaction was 4 h.

S3. Calcium hydroxide, sodium hydroxide, and a catalyst were added subsequently to the reaction device, a second hydrolysis reaction was conducted to obtain a second gas, and the second gas was introduced into the gas collection cabinet.

During the second hydrolysis reaction, a solid-to-liquid ratio of the secondary aluminum ash to the water was 1:5; and the second hydrolysis reaction was conducted at 85° C. Sodium hydroxide, sodium stannate, and calcium hydroxide were added to the reaction device, where an amount of the sodium hydroxide was 3% of an amount of the secondary aluminum ash, an amount of the sodium stannate was 1.5% of the amount of the secondary aluminum ash, and an amount of the calcium hydroxide was 15% of the amount of the secondary aluminum ash. A preset time for the second hydrolysis reaction was 50 h to 60 h.

S4. A gas mixture in the gas collection cabinet was subjected to separation and purification to obtain hydrogen.

The gas mixture in the gas collection cabinet was cooled to 35° C. or lower, ammonia was absorbed with an ammonia spray and absorption tower, and hydrogen was separated from other gases through PSA to obtain hydrogen with a purity of 99.99% or higher.

### Comparative Example 1

A method for preparing hydrogen from secondary aluminum ash was provided, including the following steps:

S1. Secondary aluminum ash was prepared, and a reaction device was subjected to an oxygen replacement treatment.

The secondary aluminum ash had a particle size of less than 100 μm; and air in the reaction device was replaced with nitrogen to make a volume proportion of oxygen in the reaction device less than 0.2%.

S2. The secondary aluminum ash was fed into the reaction device, water was added, a hydrolysis reaction was conducted to obtain a gas, and the gas was introduced into a gas collection cabinet.

During the hydrolysis reaction, a solid-to-liquid ratio of the secondary aluminum ash to the water was 1:5; the hydrolysis reaction was conducted at 85° C.; and a preset time for the hydrolysis reaction was 50 h to 60 h.

S3. A gas mixture in the gas collection cabinet was subjected to separation and purification to obtain hydrogen.

The gas mixture in the gas collection cabinet was cooled to 35° C. or lower, ammonia was absorbed with an ammonia spray and absorption tower, and hydrogen was separated from other gases through PSA to obtain hydrogen with a purity of 99.99% or higher.

### Comparative Example 2

A method for preparing hydrogen from secondary aluminum ash was provided, including the following steps:

S1. Secondary aluminum ash was prepared, and a reaction device was subjected to an oxygen replacement treatment.

The secondary aluminum ash had a particle size of less than 100 μm; and air in the reaction device was replaced with nitrogen to make a volume proportion of oxygen in the reaction device less than 0.2%.

S2. The secondary aluminum ash was fed into the reaction device, water, calcium hydroxide, sodium hydroxide, and a catalyst were added, a hydrolysis reaction was conducted to obtain a gas, and the gas was introduced into a gas collection cabinet.

During the hydrolysis reaction, a solid-to-liquid ratio of the secondary aluminum ash to the water was 1:5; and the hydrolysis reaction was conducted at 85° C. An amount of the sodium hydroxide was 3% of an amount of the secondary aluminum ash, an amount of the sodium stannate was 1.5% of the amount of the secondary aluminum ash, and an amount of the calcium hydroxide was 15% of the amount of the secondary aluminum ash. A preset time for the hydrolysis reaction was 50 h to 60 h.

S3. A gas mixture in the gas collection cabinet was subjected to separation and purification to obtain hydrogen.

The gas mixture in the gas collection cabinet was cooled to 35° C. or lower, ammonia was absorbed with an ammonia spray and absorption tower, and hydrogen was separated from other gases through PSA to obtain hydrogen with a purity of 99.99% or higher.

The gas mixture in the gas collection cabinet obtained in each of Examples 1 to 3 and Comparative Examples 1 and 2 was tested for main gas components and relative contents thereof before undergoing separation and purification, and test results were shown in Table 1.

TABLE 1
Gas components and relative contents thereof in the gas mixture obtained in
each of Examples 1 to 3 and Comparative Examples 1 and 2 (volume fraction, %)

| | | | | Carbon | Hydrogen | |
|---|---|---|---|---|---|---|
| | Hydrogen | Methane | Ammonia | dioxide | phosphate | |
| | content | content | content | content | content | Other |
| Example 1 | 69 | 1.5 | 29 | 0.2 | 0.1 | 0.2 |
| Example 2 | 68 | 2 | 29.5 | 0.18 | 0.12 | 0.2 |
| Example 3 | 67 | 2.3 | 30.2 | 0.18 | 0.1 | 0.22 |
| Comparative | 60 | 2.3 | 37 | 0.25 | 0.15 | 0.3 |
| Example 1 | | | | | | |
| Comparative | 62 | 2.5 | 35 | 0.25 | 0.15 | 0.2 |
| Example 2 | | | | | | |

It can be seen from the data in Table 1 that the present disclosure subjects active substances in the secondary aluminum ash to two-stage hydrolysis under different conditions, including a first hydrolysis reaction and a second hydrolysis reaction, where during the first hydrolysis reaction, water is only added to react with active substances in the secondary aluminum ash, which can consume aluminum nitride and aluminum carbide in the secondary aluminum ash to some extent; and during the second hydrolysis reaction, calcium hydroxide, sodium hydroxide, and a catalyst are added to make elemental aluminum completely hydrolyzed, thereby improving a hydrogen yield; and calcium hydroxide can reduce free fluorides in a solution, thereby reducing the toxicity of process products.

The above are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

1. A method for preparing hydrogen from secondary aluminum ash, comprising the following steps:
S1. preparing secondary aluminum ash, and subjecting a reaction device to an oxygen replacement treatment;
S2. feeding the secondary aluminum ash into the reaction device, adding water, conducting a first hydrolysis reaction to obtain a first gas, and introducing the first gas into a gas collection cabinet;
S3. adding calcium hydroxide and sodium hydroxide subsequently to the reaction device, conducting a second hydrolysis reaction to obtain a second gas, and introducing the second gas into the gas collection cabinet; and
S4. subjecting a gas mixture in the gas collection cabinet to separation and purification to obtain hydrogen,
wherein a reaction time of the second hydrolysis reaction is longer than a reaction time of the first hydrolysis reaction.

2. The method for preparing hydrogen from secondary aluminum ash according to claim 1, wherein in S1, the secondary aluminum ash has a particle size of less than 100 μm; and
during the oxygen replacement treatment, air in the reaction device is replaced with an inert gas to make a volume proportion of oxygen in the reaction device less than 0.2%.

3. The method for preparing hydrogen from secondary aluminum ash according to claim 1, wherein in S2, during the first hydrolysis reaction, a solid-to-liquid ratio of the secondary aluminum ash to the water is 1:(3-8); the first hydrolysis reaction is conducted at 25° C. to 60° C.; and
the first hydrolysis reaction is carried out for 4 h to 20 h.

4. The method for preparing hydrogen from secondary aluminum ash according to claim 1, wherein in S2, during the first hydrolysis reaction, a solid-to-liquid ratio of the secondary aluminum ash to the water is 1:(4-7); the first hydrolysis reaction is conducted at 35° C. to 55° C.; and
the first hydrolysis reaction is carried out for 5 h to 15 h.

5. The method for preparing hydrogen from secondary aluminum ash according to claim 1, wherein in S3, an amount of the calcium hydroxide added is 5% to 50% of an amount of the secondary aluminum ash; and
an amount of the sodium hydroxide added is 1% to 10% of the amount of the secondary aluminum ash.

6. The method for preparing hydrogen from secondary aluminum ash according to claim 1, wherein in S3, an amount of the calcium hydroxide added is 8% to 20% of an amount of the secondary aluminum ash; and
an amount of the sodium hydroxide added is 3% to 5% of the amount of the secondary aluminum ash.

7. The method for preparing hydrogen from secondary aluminum ash according to claim 1, wherein in S3, during the second hydrolysis reaction, a solid-to-liquid ratio of the secondary aluminum ash to the water is 1:(3-8); the second hydrolysis reaction is conducted at 50° C. to an initial pH for the second hydrolysis reaction is 11 to 14; and
the second hydrolysis reaction is carried out for 20 h to 60 h.

8. The method for preparing hydrogen from secondary aluminum ash according to claim 1, wherein in S3, the calcium hydroxide, the sodium hydroxide, and a catalyst are added to the reaction device to conduct the second hydrolysis reaction; and an amount of the catalyst added is to 10% of an amount of the secondary aluminum ash, and
the catalyst is one or more selected from the group consisting of hydrogen peroxide, sodium carbonate, potassium carbonate, potassium hydroxide, and sodium stannate.

9. The method for preparing hydrogen from secondary aluminum ash according to claim 8, wherein in S3, during the second hydrolysis reaction, the sodium hydroxide and the catalyst are first added to react for 10 h to 30 h, and then the calcium hydroxide is added.

10. The method for preparing hydrogen from secondary aluminum ash according to claim 1, wherein the gas mixture in the gas collection cabinet is subjected to separation and purification as follows:
cooling the gas mixture in the gas collection cabinet to 35° C. or lower, absorbing ammonia with a spray absorption tower for ammonia, and separating hydrogen through pressure swing adsorption (PSA) to obtain hydrogen with a purity of 99.99% or higher.
